(19) United States
(12) Patent Application Publication
(10) Pub. No.: US 2010/0253588 A1
(43) Pub. Date: Oct. 7, 2010

(54) Portal Stand for RFID Antenna

(75) Inventor: Donald T. Lee, Frederick, MD (US)

Correspondence Address: FROST BROWN TODD, LLC, 2200 PNC CENTER, 201 E. FIFTH STREET, CINCINNATI, OH, 45202, US

(73) Assignee: Jamison Door Company, Hagerstown, MD (US)

(21) Appl. No.: 12/750,817

(22) Filed: Mar. 31, 2010

Related U.S. Application Data
(60) Provisional application No. 61/166,289, filed on Apr. 3, 2009.

(51) Int. Cl. H01Q 1/12; B23P 11/00; F16M 11/04

(52) U.S. Cl. 343/878; 29/428; 248/121

(57) ABSTRACT

A portal stand for an RFID antenna comprises a pair of upright members and a front cover. The front cover is formed of a sheet of plastic that is resiliently biased to assume a flat configuration, with the front cover defining a flat width when it is in the flat configuration. The upright members include vertical slots and are spaced apart at a distance that is less than the flat width of the front cover. The front cover is disposed in the vertical slots and is bowed outwardly. The portal stand also includes a plurality of platforms that may be used for mounting RFID equipment such as antennas and readers. The platforms are secured to rails that are also secured to the upright members. The portal stand also includes a top cover, bottom cover, and rear cover, with the platforms being positioned between the front cover and rear cover.

### PRIORITY

This application claims priority to U.S. Provisional Patent Application Ser. No. 61/166,289, filed Apr. 3, 2009, entitled “Portal Stand for RFID Antenna,” the disclosure of which is incorporated by reference herein.

### BACKGROUND

In some settings, it may be desirable to place a portal stand at or near a doorway, with one or more Radio Frequency Identification (RFID) and/or Electronic Article Surveillance (EAS) antennas and associated components mounted to such a portal stand. Such a portal stand may be placed at, near, or within an open doorway (e.g., one without any doors), a doorway having doors, or in a variety of other locations. Merely illustrative examples of settings in which such doorways may be located include department stores (e.g., at the main entry/exit and/or loading dock(s), among other places), grocery stores (e.g., at the main entry/exit and/or loading dock(s), among other places), warehouses (e.g., at the main entry/exit and/or loading dock(s) and/or locations between storage rooms, etc.), etc. Of course, such portal stands may be positioned at a variety of other locations, including but not limited to locations that are not at, near, or within a doorway. Various suitable locations for positioning a portal stand as described herein will be apparent to those of ordinary skill in the art in view of the teachings herein. While a variety of stands have been made and used for RFID and/or EAS equipment, it is believed that no one prior to the inventor has made or used an invention as described herein.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a perspective view of an exemplary portal stand;

FIG. 2 depicts a front view of the portal stand of FIG. 1, with a front cover removed;

FIG. 3 depicts a cross-sectional view of the portal stand of FIG. 1, taken along line 3-3 of FIG. 2; and

FIG. 4 depicts a front view of the portal stand of FIG. 1, with a front cover removed, and with additional components in the portal stand.

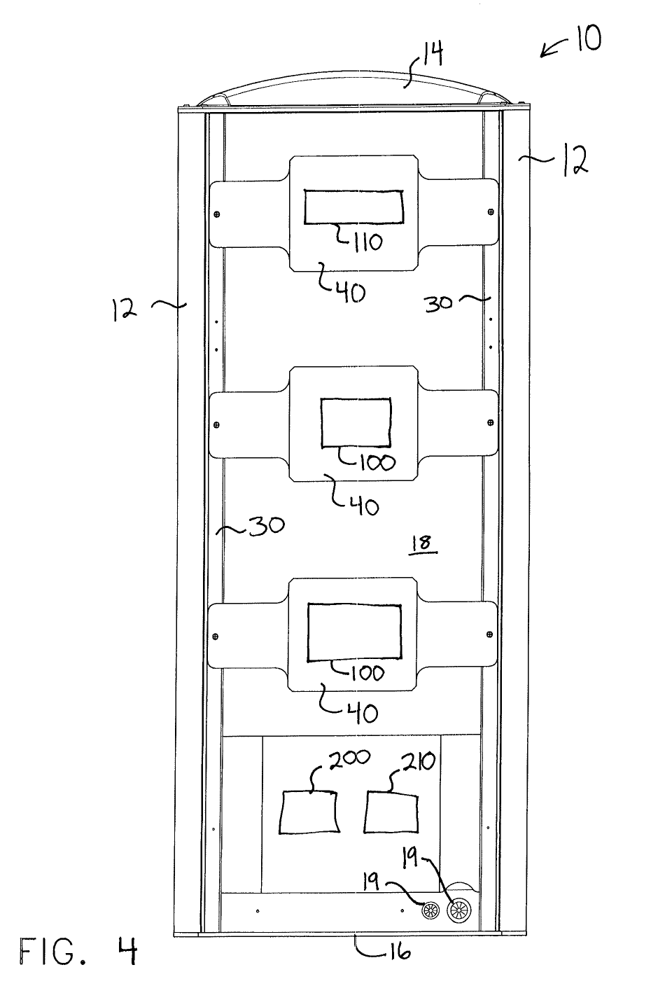

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

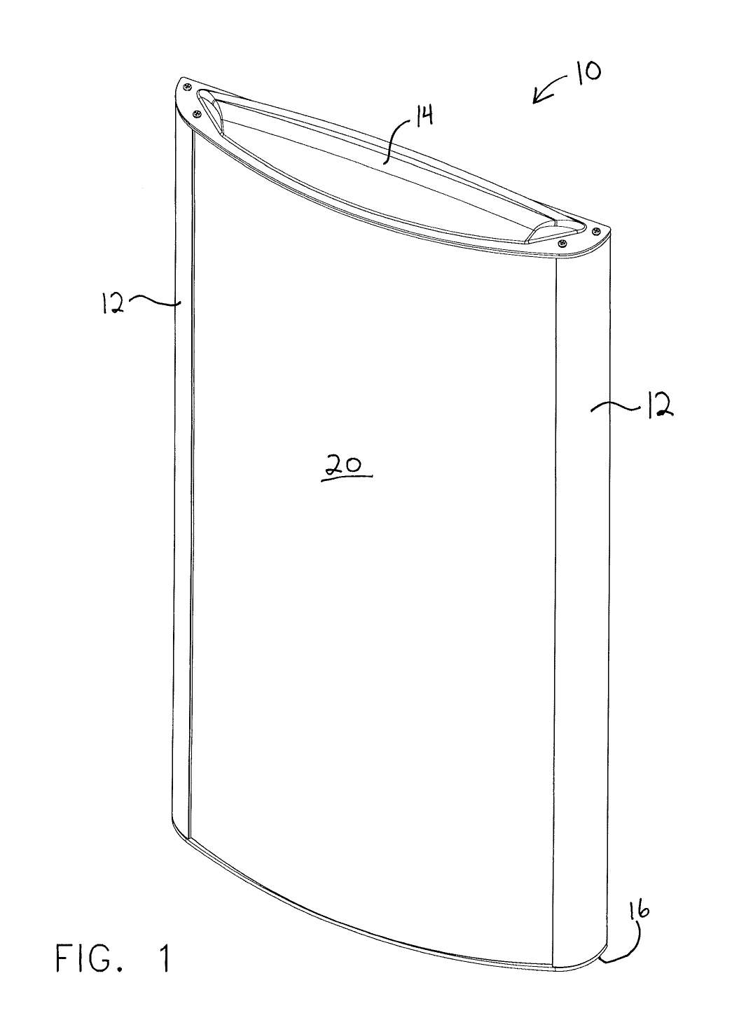

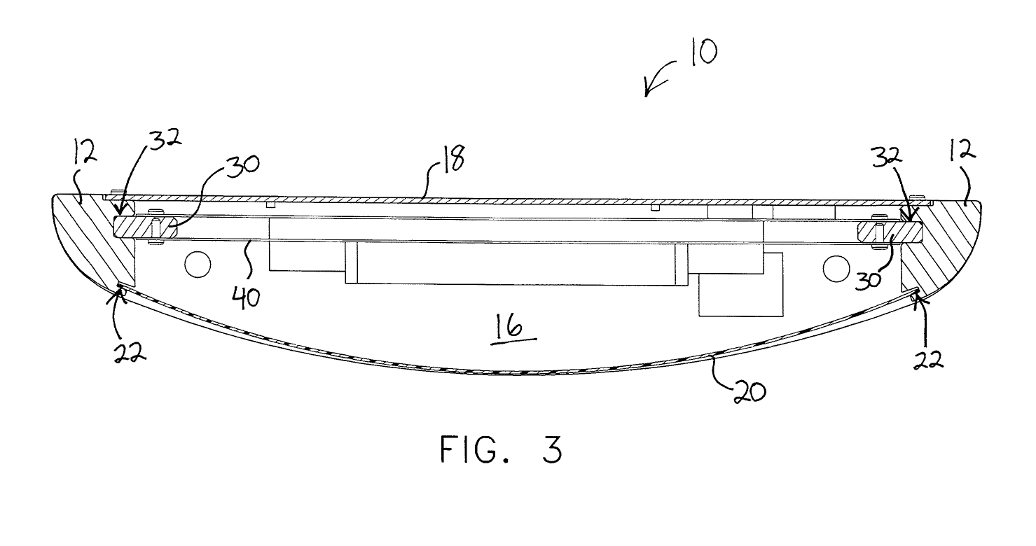

As shown in FIGS. 1-3, an exemplary portal stand (10) includes a pair of side members (12), a top cover (14), a bottom cover (16), a rear cover (18), and a front cover (20). Side members (12) may be made of various materials, including but not limited to metal (e.g., aluminum, etc.), plastic, or wood, including combinations thereof. Side members (12) may also be formed using a variety of techniques, including but not limited to extrusion, molding, milling, etc. As best seen in FIG. 3, side members (12) include a curved front face, a flat rear face, and a flat side face, such that each side member (12) has three faces. Alternatively, side members (12) may have any other suitable configuration.

In the present example, top cover (14), bottom cover (16), and rear cover (18) are made of metal, though any other suitable material(s) may be used, including but not limited to plastic or wood, etc. Also in the present example, top cover (14), bottom cover (16), and rear cover (18) are formed using a stamping process, though any other suitable techniques may be used, including but not limited to molding, etc. It should also be understood that top cover (14), bottom cover (16), and rear cover (18) need not be formed of the same material(s) or using the same techniques. Top cover (14), bottom cover (16), and rear cover (18) are all secured to side members (12) in the present example, such as by screws, bolts, adhesives, clips, etc. One or more gaskets (not shown) may also be provided between two or more of such joined components, if desired. Other suitable relationships between top cover (14), bottom cover (16), rear cover (18), and side members (12), including but not limited to ways in which such components may be coupled to or relative to each other, will be apparent to those of ordinary skill in the art in view of the teachings herein.

Front cover (20) of the present example is formed of a flexible plastic. Of course, any other suitable material may be used, including combinations thereof. Furthermore, front cover (20) may be rigid in some examples, and need not necessarily be rigid or flexible. Front cover (20) of the present example may also be opaque, translucent, or transparent, as will be described in greater detail below.

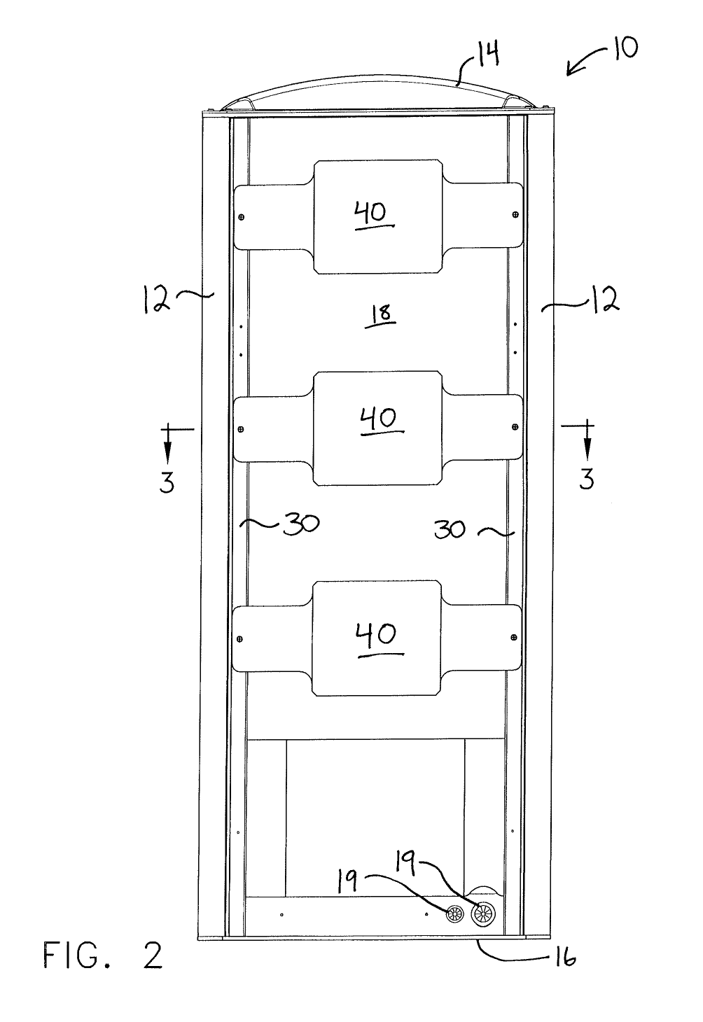

As shown in FIGS. 2-3, a pair of rails (30) are engaged with side members (12). In particular, a slot (32) is formed in each side member (12), and each rail (30) is inserted into the slot (32) of a corresponding side member (12). Each slot (32) runs the entire length of its corresponding side member (12), though slots (32) may have any other suitable length. Each slot (32) is also substantially perpendicular to the flat side face of its corresponding side member (12), though slots (32) may have any other suitable orientation. It should also be understood that rails (30) may engage with side members (12) in a variety of other ways using a variety of other structures (e.g., brackets, etc.) or techniques, in addition to or in lieu of insertion in slots (32). As another merely illustrative example, rails (30) may alternatively be coupled with rear cover (18), bottom cover (16), and/or top cover (14) in any suitable fashion.

In the present example, a plurality of platforms (40) are coupled with rails (30). While three platforms (40) are shown in FIG. 2, it should be understood that any other suitable number of platforms (40) may be provided. Platforms (40) of this example are configured to receive components of RFID and/or EAS systems, including but not limited to antennas (100) and/or readers (110) of such systems as shown in FIG. 5. For instance, components of conventional, off-the-shelf RFID and/or EAS systems may be coupled with platforms (40) using clips, brackets, bolts, adhesives, other types of fasteners, or using any other suitable structures or techniques. It should also be understood that components of RFID and/or EAS systems may be secured to or within portal stand (10) using one or more components other than platforms (40) (e.g., placed on bottom cover (16), etc.). Furthermore, it should be understood that a variety of other types of components may be provided within portal stand (10), in addition to or in lieu of RFID and/or EAS components. As is also shown in FIG. 2, a plurality of openings (19) are formed in rear cover (18), permitting wires and cables, etc. to pass through rear cover (18) into the interior of portal stand (10). Of course, openings (19) may be provided in various other locations, in addition to or in lieu of being provided in rear cover (18). Openings (19) of the present example include rubber bushings, though as with other components described herein, such bushings are merely optional.

In the present example, RFID and/or EAS components within portal stand (10) are in communication with one or more computer systems via wires that pass through openings (19). Such computer systems may include one or more computers located in the same facility in which portal stand (10) is located. In addition or in the alternative, such computer systems may include one or more computers that are remote from the facility in which portal stand (10) is located. Such remote communication may be carried out using one or more private networks, one or more public networks, combinations of public and private networks, or in any other suitable fashion. RFID and/or EAS components within portal stand (10) may also receive power via wires that pass through openings (19). In some other versions, RFID and/or EAS components within portal stand (10) are in wireless communication with one or more computer systems, such that openings (19) are not necessarily required. Similarly, RFID and/or EAS components within portal stand (10) may be powered by a battery, solar panel, and/or some other local source, such that the components do not need to receive power via wires that pass through openings (19). In some versions, components within portal stand (10) (e.g., an RFID reader, etc.) are powered by one or more Ethernet cables using Power over Ethernet (PoE) technology. Thus, such components may use Ethernet cables for communication of data, commands, etc., and power. To further enhance the use of PoE in portal stand (10), a PoE splitter may be included within portal stand (10). Other suitable ways in which components within portal stand (10) may communicate with other systems, as well as in which components within portal stand (10) may receive power, will be apparent to those of ordinary skill in the art in view of the teachings herein.

As yet another merely illustrative variation, one or more computers may be located within portal stand (10). For instance, some versions of portal stand (10) may include a feature (e.g., platform fixture, etc.) for mounting a conventional laptop computer (not shown) in portal stand (10). Such a laptop computer may be coupled with RFID and/or EAS components that are also within portal stand (10). In particular, RFID and/or EAS components may be communicatively coupled with such a laptop computer via one or more wires and/or wirelessly. Such a laptop computer may include software that is configured to drive or operate RFID and/or EAS components in portal stand (10). In addition or in the alternative, such a laptop computer may include software that is configured to process data obtained from RFID and/or EAS components in portal stand (10). Various suitable ways in which a laptop computer or other type of computer may communicate with RFID and/or EAS components in portal stand (10) will be apparent to those of ordinary skill in the art in view of the teachings herein. Furthermore, it should be understood that such a laptop computer may be in communication with one or more remote computer systems, via wire and/or wirelessly. It should also be understood that a conventional desktop computer or other type of computer may be located in portal stand, in addition to or in lieu of a laptop computer.

In some versions, portal stand (10) also includes an alarm or buzzer (not shown) and one or more light indicators (not shown). At least some of such features may be provided on, above, or near top cover (14); or in any other suitable location(s). Such an alarm and/or light may be selectively activated under a variety of conditions. For instance, an alarm and/or light may be activated when a certain RFID or EAS signal is received (e.g., indicating that a person is attempting to steal an item, indicating that an item has not been properly accounted for before passing through the portal at which portal stand (10) is located, etc.). In addition or in the alternative, such an alarm and/or light may be selectively activated based on whether an RFID or EAS reader has properly read tags on items at the portal. For instance, a red light may be illuminated by default, to indicate the need to stop or pause at portal stand (10) in order for tags to be read by RFID or EAS components. A green light may then be illuminated to indicate that tags have been satisfactorily read. As another merely illustrative example, one or more lights associated with portal stand (10) may be non-illuminated by default; and may illuminate when a reading of an RFID or EAS tag indicates that a tagged item has not been properly accounted for. As noted above, one or more alarms, buzzers, lights, etc., of portal stand (10) may be powered using PoE. Alternatively, such components may be powered in any other suitable fashion. Various other suitable ways in which an alarm, buzzer, light, etc. may be incorporated into portal stand (10) and used will be apparent to those of ordinary skill in the art in view of the teachings herein.

As noted above, front cover (20) may be formed of a flexible plastic. By way of example only, front cover (20) may comprise a sheet of plastic that is resiliently biased to assume a substantially flat configuration. Alternatively, front cover (20) may be preformed such that it rigidly assumes (or is biased to assume) a curved configuration. Front cover (20) is engaged with side members (12) in the present example. In particular, a slot (22) is formed in each side member (12), and front cover (20) is inserted in such slots (22). Each slot (22) runs the entire length of its corresponding side member (12), though slots (22) may have any other suitable length. Each slot (22) is also non-perpendicularly angled with respect to the flat side face of its corresponding side member (12), though slots (22) may have any other suitable orientation. It should also be understood that front cover (20) may engage with side members (12) in a variety of other ways using a variety of other structures or techniques, in addition to or in lieu of insertion in slots (22). As another merely illustrative example, front cover (20) may alternatively be coupled with bottom cover (16), and/or top cover (14) in any suitable fashion.

In one merely illustrative example of front cover (20) being coupled with side members (12), a portal stand (10) may be initially provided with the above described components coupled together with the exception of top cover (14) and front cover (20). In this merely illustrative example, front cover (20) is a sheet of plastic that is resiliently biased to assume a substantially flat configuration. In particular, when in a substantially flat configuration, front cover (20) of this example has a width that is greater than the distance defined between the flat side faces of side members (12). Front cover (20) is then bent to a sufficient degree to permit front cover (20) to be inserted in slots (22). The lower edge of front cover (20) in such a bent configuration is then fed in through the tops of side members (12), at slots (22), and then front cover (20) is slid down slots (22). When front cover (20) has been sufficiently fed down slots (22) (e.g., such that the lower edge of front cover (20) contacts or comes in close proximity to bottom cover (16)), top cover (14) may then be secured to side members (12). Front cover (20) is thereby secured between side members (12) and between top cover (14) and bottom cover (16). With portal stand (10) fully assembled, front cover (20) presents a bowed-out configuration, as best seen in FIG. 3.

As another merely illustrative example, front cover (20) is not slid through slots (22) from the top down. For instance, front cover (20) may be initially positioned in front of side members (12), at substantially the same vertical position of side members (12). One side edge of front cover (20) may then be inserted in a corresponding slot (22), then front cover (20) may be bent to permit the other side edge of front cover (20) to be inserted into the other slot (22). Such lateral installation of front cover (20) may even be performed with top cover (14) already secured to side members (12) in some versions. Alternatively, front cover (20) may be incorporated into portal stand (10) in a variety of other ways.

In some versions, front cover (20) and/or rear cover (18) may be used to present various types of information, including but not limited to advertisements. For instance, advertisements or other types of information may be printed directly on front cover (20) (e.g., on the front face of front cover (20) and/or on the rear face of front cover (20)). Such advertisements may relate to a variety of types of subject matter, including subject matter that is not at all related to portal stand (10) (e.g., advertisements for clothing, department stores, food, etc.). To the extent that each face of front cover (20) has information printed on it, front cover (20) may be removed from portal stand (10), flipped around to present the opposite face, then reinserted in portal stand (10) to show the information on the opposite face. In some other versions, front cover (20) is substantially transparent, and slots (22) provide sufficient clearance to allow a piece of paper/cardboard/plastic/metal/etc. having information printed thereon to be slid into slots (22) along with front cover (20) (e.g., behind front cover (20)). It should also be understood that one or more lights (200) may be provided within portal stand (10), such as to provide backlighting of front cover (20) and any information that is printed thereon or viewed therethrough. As yet another merely illustrative example, where front cover (20) may be translucent, and a projector (210) may be provided within portal stand (10) to provide rear projection of information (e.g., text, photographs, video, etc.) onto front cover (20), with such rear projected information being visible from the front of front cover (20). Such a projector (210) may be coupled with a remote computer, allowing the projected information to be changed without having to disassemble any components of portal stand (10). Still other ways in which various types of information may be provided on and/or through front cover (20) will be apparent to those of ordinary skill in the art in view of the teachings herein.

Portal stand (10) may be mounted in a variety of ways. By way of example only, bottom cover (16) may be bolted (e.g., using concrete anchors, etc.), clipped/clamped, or otherwise secured to a floor. As another merely illustrative example, rear cover (18), side member(s) (12), and/or platform (40) may be bolted or clipped/clamped to a wall or door frame; or otherwise secured to a wall or door frame. As yet another merely illustrative example, portal stand (10) may simply rest on a floor (e.g., with bottom cover (16) contacting the floor, with one or more feet between bottom cover (16) and the floor, etc.). Still other ways in which portal stand (10) may be mounted will be apparent to those of ordinary skill in the art in view of the teachings herein.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of claims that may be presented, and is understood not to be limited to the details of structure and operation shown and described in the specification and drawings.

I claim:

1. A portal stand for an RFID antenna, the portal stand comprising:
(a) a pair of upright members, wherein the upright members are spaced apart at a first distance, wherein each of the upright members defines a first slot running along at least a portion of the length of the respective upright member;
(b) a front cover positioned in the first slots of the upright members, wherein the front cover is configured to define a first width when the front cover is not positioned in the slots of the upright members, wherein the first width is greater than the first distance such that the front cover is bowed when the front cover is positioned in the slots of the upright members; and
(c) a mounting member configured to receive one or more RFID system components.

2. The portal stand of claim 1, further comprising a top cover, wherein the top cover is secured to top ends of the upright members.

3. The portal stand of claim 1, further comprising a bottom cover, wherein the bottom cover is secured to bottom ends of the upright members.

4. The portal stand of claim 1, further comprising a rear cover secured to the upright members.

5. The portal stand of claim 4, wherein the rear cover includes at least one opening configured to permit one or more wires to pass through the rear cover.

6. The portal stand of claim 4, wherein the mounting member is positioned between the front cover and the rear cover.

7. The portal stand of claim 1, wherein the front cover is formed of a flexible plastic.

8. The portal stand of claim 1, wherein the front cover is resiliently biased to assume a substantially flat configuration.

9. The portal stand of claim 1, wherein the mounting member comprises a platform.

10. The portal stand of claim 1, further comprising a pair of rails secured to the upright members, wherein the mounting member is secured to the pair of rails.

11. The portal stand of claim 10, wherein each of the upright members further defines a second slot, wherein the rails are at least partially inserted in the second slots of the upright members.

12. The portal stand of claim 1, further comprising an RFID antenna secured to the mounting member.

13. The portal stand of claim 1, further comprising an RFID reader secured to the mounting member.

14. The portal stand of claim 1, wherein the front cover bears one or more advertisements.

15. The portal stand of claim 1, further comprising one or more light sources operable to illuminate the front cover from behind the front cover.

16. The portal stand of claim 1, further comprising one or more projectors operable to project information on the front cover from behind the front cover.

17. The portal stand of claim 1, wherein the front cover is translucent.

18. A portal stand for an RFID antenna, the portal stand comprising:
(a) a pair of upright members, wherein the upright members are spaced apart at a first distance, wherein each of the upright members defines a respective slot running along at least a portion of the length of the respective upright member;
(b) a rear cover secured to the upright members;
(c) a front cover positioned between the upright members and in the slots of the upright members, wherein the front cover is bowed outwardly away from the rear cover;
(d) a plurality of mounting platforms secured relative to the upright members, wherein the mounting platforms are positioned between the front cover and the rear cover; and
(e) one or both of an RFID antenna or an RFID reader secured to one or more of the mounting platforms.

19. A method of assembling a portal stand for an RFID antenna, wherein the portal stand comprises a pair of upright members and a flexible front cover, wherein the upright members each define a vertical slot, wherein the flexible front cover has a first width defined by outer side edges of the front cover, the method comprising:
(a) positioning the upright members vertically, such that the upright members are positioned at a first distance apart from each other, wherein the first distance is less than the first width of the front cover;
(b) securing the upright members in position at the first distance apart from each other;
(c) bending the flexible front cover such that the flexible front cover has an effective second width, wherein the effective second width is less than the first width; and
(d) positioning the outer side edges of the front cover in the slots of the upright members to secure the front cover to the upright members.

20. The method of claim 19, wherein top portions of the vertical slots extend to respective top portions of the upright members, wherein the act of positioning the outer side edges of the front cover in the slots of the upright members comprises:
(i) inserting bottom portions of the outer side edges of the front cover into the top portions of the vertical slots, and
(ii) sliding the front cover vertically downward relative to the upright members with the outer side edges of the front cover disposed in the vertical slots of the upright members.
